(19) United States
(12) Patent Application Publication
(10) Pub. No.: US 2003/0014236 A1
(43) Pub. Date: Jan. 16, 2003

(54) Method and device for assessing performance of micropreocessor execution

(76) Inventor: Ching-Jer Liang, Hsinchu Hsien (TW)

Correspondence Address: J.C. Patents, Inc., Suite 250, 4 Venture, Irvine, CA, 92618, US

(21) Appl. No.: 10/037,894

(22) Filed: Oct. 22, 2001

(30) Foreign Application Priority Data
Jul. 11, 2001 (TW) 90116947

(51) Int. Cl. G06F 9/455

(52) U.S. Cl. 703/26

(57) ABSTRACT

A method of determining the performance of a microprocessor during execution. The method is implemented using a microprocessor, an instruction counter and a cycle counter. First, the microprocessor is triggered into an emulation mode. The instruction counter and the cycle counter is reset to zero. Assessment points are set up along a series of instruction whose operating speed needs to be determined. The microprocessor jumps from the circuit emulation mode into a normal operating mode and then executes a series of program instructions. The instruction counter increments by one when an instruction is executed. Similarly, the cycle counter increments by one when one cycle of timing pulse is traversed. When an assessment point is encountered during instruction execution, the microprocessor jumps from the normal operating mode back into the circuit emulation mode. Microprocessor performance is evaluated by dividing the value inside the cycle counter by the value inside the instruction counter. If the value inside the counter reaches an upper limit, the microprocessor jumps from the normal operating mode back to the circuit emulation mode After evaluating microprocessor performance, the microprocessor jumps into the circuit emulation mode again until all instructions are executed or another assessment point is encountered.

### CROSS-REFERENCE TO RELATED APPLICATION

This application claims the priority benefit of Taiwan application serial no. 90116947, filed Jul. 11, 2001.

### BACKGROUND OF THE INVENTION

1. Field of Invention

The present invention relates to a method of assessing the performance of an execution. More particularly, the present invention relates to a method and a device for assessing the performance of microprocessor execution.

2. Description of Related Art

Most conventional microprocessor has the facilities to check if a particular instruction is executed normally or encountered any logical errors. In general, there is no associated device for determining the operating speed of a particular instruction. However, operating speed of instructions is especially relevant to the overall design of a computer or application programming.

### SUMMARY OF THE INVENTION

Accordingly, one object of the present invention is to provide a method of assessing the performance of a microprocessor execution so that any problem area can be deal with appropriately.

To achieve these and other advantages and in accordance with the purpose of the invention, as embodied and broadly described herein, the invention provides a method of assessing the performance of a microprocessor during execution. The method can be applied to a microprocessor having both a circuit emulation mode and normal operating mode for assessing the performance of an execution that includes a plurality of instructions. The method includes the following steps. First, the microprocessor is triggered into an emulation mode. An instruction counter and a cycle counter is reset to zero. The microprocessor is triggered into a normal operating mode for executing a program. The instruction counter starts to count and increments by one every time an instruction is executed. When the instruction counter reaches an upper limit, the microprocessor is triggered into a circuit emulation mode to read off the value in the instruction counter and the cycle counter and then produced a report on the performance of the execution. The microprocessor is again triggered into the normal operation mode. At the same time, the cycle counter value starts to count and increments the counter by one each time a timing pulse traverses a cycle. When the value in the cycle counter reaches an upper limit, the microprocessor is triggered into a circuit emulation mode and read off the value in the instruction counter and the cycle counter and produces a report on the performance of the execution. The microprocessor is again triggered into a normal operation mode. When the program is executed to a definite point, the microprocessor is triggered into a circuit emulation mode After reading off the values from the instruction counter and the cycle counter, a performance report of the execution is produced.

The aforementioned method of assessing the performance of execution of a microprocessor further includes the following steps. When the execution is completed, the microprocessor is triggered into the circuit emulation mode and read off values inside the instruction counter and the cycle counter and produces a performance report.

In addition, the aforementioned method of assessing the performance of execution of a microprocessor includes the following steps. Assessment points are set up along a program where instruction execution speed is required. In the process of executing the instructions, the microprocessor is triggered into a circuit emulation mode when one such assessment point is encountered. Thereafter, values inside the instruction counter and the cycle counter are read off and performance of the execution is reported.

This invention also provides a second method of assessing the performance of execution of a microprocessor having the following steps. Assessment points are set up along a program where instruction execution speed is required. In the process of executing the instructions, the microprocessor is triggered into a circuit emulation mode when one such assessment point is encountered. Thereafter, values inside the instruction counter and the cycle counter are read off. The microprocessor is again triggered into a circuit emulation mode. The instruction counter and the cycle counter are reset to zero. The microprocessor is triggered into a normal operating mode to execute a program. The instruction counter starts to count and increments by one every time an instruction is executed. In the meantime, the cycle counter also starts to count and increments by one every time a timing pulse traverses a cycle. On reaching the last assessment point of the instructions, the microprocessor is triggered into a circuit emulation mode and read off the values in the instruction counter and the cycle counter to produce a performance report. The method of reporting the execution performance of the microprocessor includes dividing the value in the cycle counter by the value in the instruction counter.

This invention also provides a device for assessing the performance of microprocessor execution. The device includes a microprocessor, an instruction counter and a cycle counter. The microprocessor is capable of operating in a circuit emulation mode and a normal operating mode. The instruction counter is capable or incrementing the value inside the counter by one after the execution of each instruction. Moreover, when the value inside the instruction counter reaches an upper value, the microprocessor is triggered into a circuit emulation mode and read off the value inside the instruction counter and the cycle counter. The cycle counter is capable of incrementing the value inside the counter by one after a timing pulse traverse each cycle. Moreover, when the value inside the cycle counter reaches an upper value, the microprocessor is triggered into a circuit emulation mode and read off the value inside the instruction counter and the cycle counter. The performance of the microprocessor is reported as a value obtained by dividing the value in the cycle counter by the value in the instruction counter.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a flow chart showing the steps in a method of assessing the performance of a microprocessor according to this invention;

FIG. 2 is a timing diagram showing instruction and cycle counting according to the method shown FIG. 1;

FIG. 3 is a flow chart showing the steps in an alternative method of assessing the performance of microprocessor execution according to this invention;

FIG. 4 is a timing diagram showing a method of counting instructions and cycles according to the method shown FIG. 3; and

FIG. 5 is a timing diagram showing an alternative method of counting instructions and cycles according to the method shown FIG. 3.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

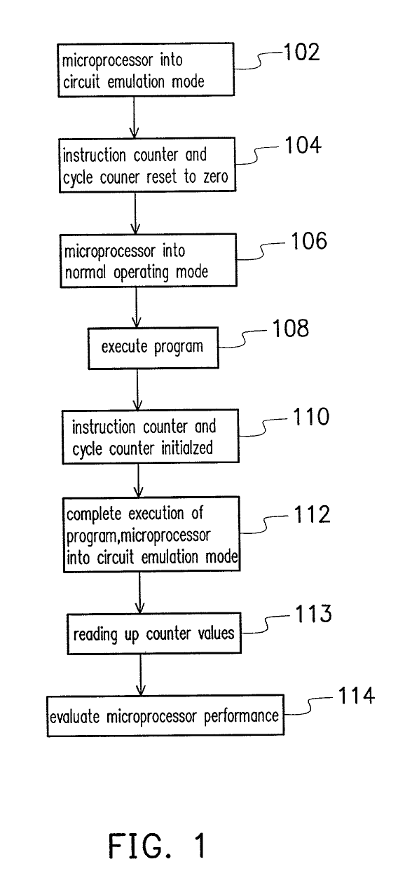

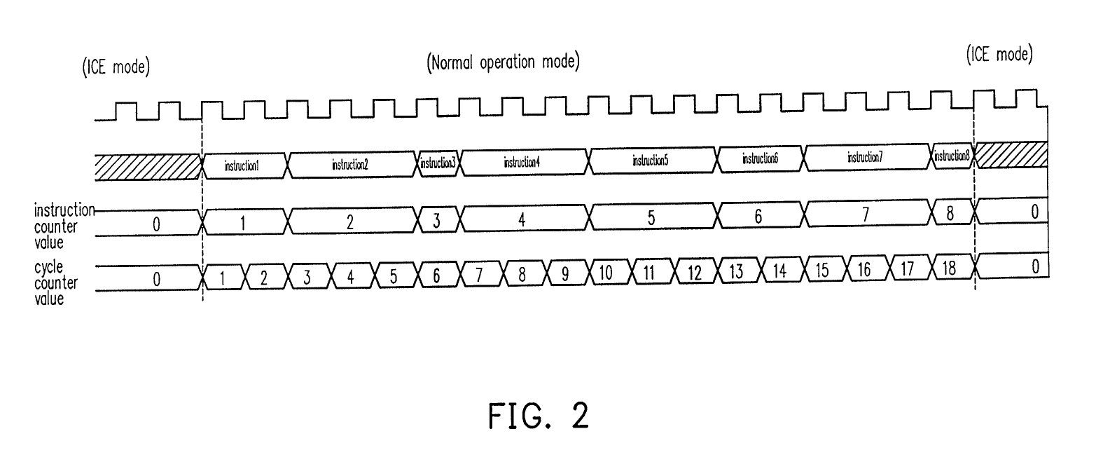

FIG. 1 is a flow chart showing the steps in a method of assessing the performance of a microprocessor according to this invention. FIG. 2 is a timing diagram showing instruction and cycle counting according to the method shown FIG. 1. In this embodiment, a microprocessor, an instruction counter and a cycle counter are used. First, in step 102, the microprocessor is triggered into a circuit emulation mode. In step 104, an instruction counter and a cycle counter is reset to zero. In step 106, the microprocessor jumps from the circuit emulation mode into a normal operating mode. In step 108, the microprocessor executes a plurality of instructions demanded by a program. In step 110, the instruction counter starts to count and increments by one every time an instruction is executed. At the same time, the cycle counter value starts to count and increments the counter by one each time a timing pulse traverses a cycle. When all instructions have been executed, the microprocessor jumps from the normal operating mode back to the circuit emulation mode in step 112. In step 113, values in the instruction counter and the cycle counter are read out. In step 114, performance of the microprocessor is evaluated.

As shown in FIG. 2, a total of eighteen cycles is required to execute eight instructions. Therefore, on average, each instruction needs 18/8 cycles.

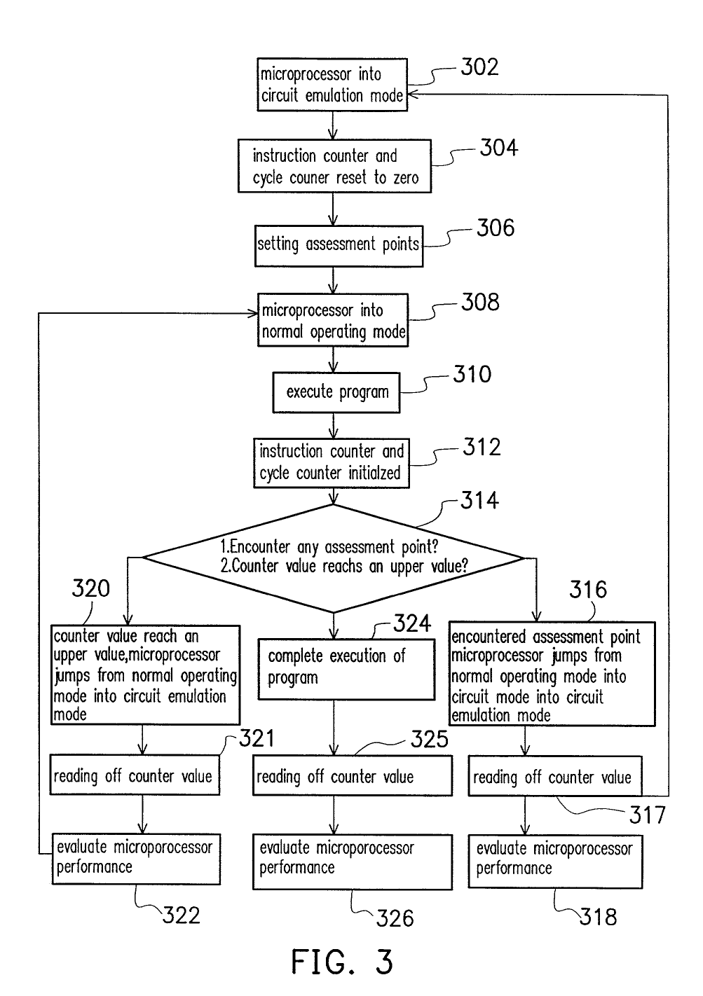

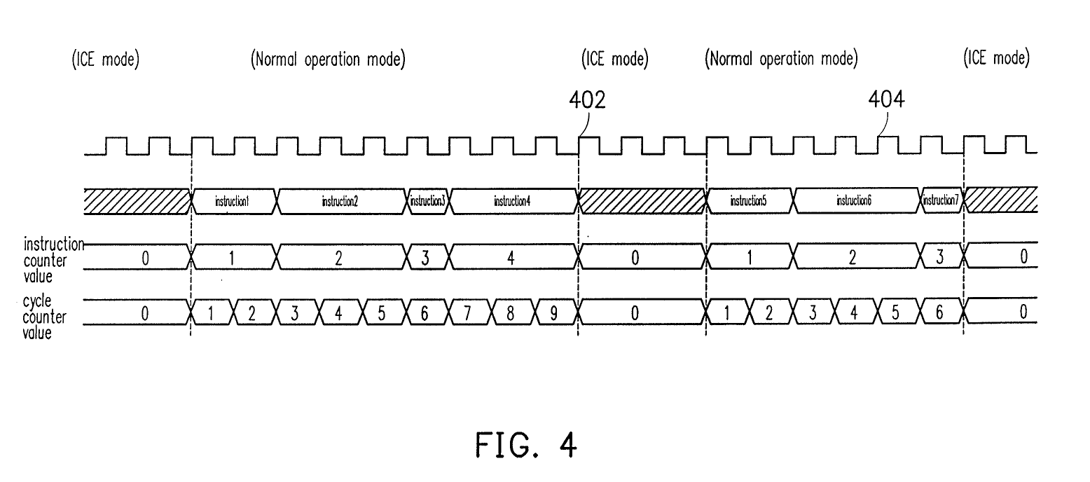

FIG. 3 is a flow chart showing the steps in an alternative method of assessing the performance of microprocessor execution according to this invention. FIG. 4 is a timing diagram showing a method of counting instructions and cycles according to the method shown FIG. 3. In this embodiment, a microprocessor, an instruction counter and a cycle counter is used. Assume the instruction counter and the cycle counter both have a counting limit of 9. First, in step 302, the microprocessor is triggered into a circuit emulation mode. In step 304, the value inside the instruction counter and the cycle counter are reset to zero. In step 306, an assessment point is set at the seventh instruction. In step 308, the microprocessor jumps from the emulation mode to a normal operating mode. In step 310, a plurality of instructions in a program is executed. In step 312, both the instruction counter and the cycle counter start to count. The instruction counter is incremented by one when an instruction is executed. Similarly, the cycle counter is incremented by one when a timing pulse is traversed. On executing the fourth instruction, the cycle counter has already reached the upper limit 9 in step 314 (label 402 in FIG. 4). In step 320, the microprocessor jumps from the normal operating mode into a circuit emulation mode. In step 321, value inside the instruction counter and the cycle counter are read out. In step 322, performance of the microprocessor is evaluated. The microprocessor then branches back to step 302 such that the circuit emulation mode is again triggered. Thereafter, the instruction counter and the cycle counter are reset to zero in step 304. The assessment point is set to 7 in step 306 In step 308, the microprocessor jumps from the circuit emulation mode into the normal operating mode. In step 310, the program is executed. In step 312, the instruction counter and the cycle counter start to count. The instruction counter is incremented by one when an instruction is executed. Similarly, the cycle counter is incremented by one when a timing pulse is traversed. On reaching the seventh instruction, the assessment point is encountered in step 314 (label 404 in FIG. 4). Hence, the microprocessor jumps from the normal operating mode back to the circuit emulation mode in step 316. In step 317, values inside the instruction counter ad the cycle counter are read out. Finally, in step 318, performance of the microprocessor is evaluated.

As shown in FIG. 4, nine cycles are used to execute instructions 1 to 4. Hence, on average, each instruction requires 9/4 cycles. Similarly, six cycles are used to execute instructions 5 to 7. Thus, on average, each instruction requires 6/3 cycles.

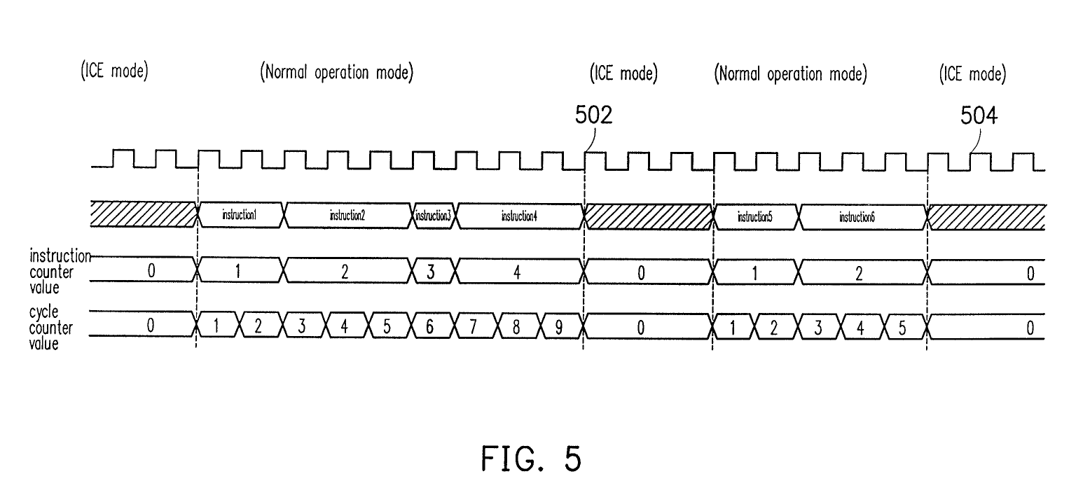

FIG. 3 is also a flow chart that shows the steps in yet another alternative method of assessing the performance of microprocessor execution according to this invention. FIG. 5 is a timing diagram showing an alternative method of counting instructions and cycles according to the method shown FIG. 3. In this embodiment, a microprocessor, an instruction counter and a cycle counter is used. To find the performance for executing the instructions 4 to 6, the first microprocessor is triggered into a circuit emulation mode in step 302. In step 304, the value inside the instruction counter and the cycle counter are reset to zero. In step 306, an assessment point is set after the fourth and the sixth instructions. In step 308, the microprocessor jumps from the emulation mode to a normal operating mode. In step 310, a plurality of instructions in a program is executed. In step 312, both the instruction counter and the cycle counter start to count. The instruction counter is incremented by one when an instruction is executed. Similarly, the cycle counter is incremented by one when a timing pulse is traversed. On executing the fourth instruction, the assessment point is reached in step 314 (label 502 in FIG. 5) so that the microprocessor jumps away form the normal operating mode into the circuit emulation mode in step 316. In step 317, the value inside the instruction counter and the cycle counter are read out and control is returned to step 302. In step 304, the instruction counter and the cycle counter are reset to zero. In step 306, an assessment point is set after the sixth instruction. In step 308, the microprocessor jumps from the circuit emulation mode into a normal operating mode. In step 310, execution of the program is initiating. In step 312, both the instruction counter and the cycle counter start to count. The instruction counter is incremented by one when an instruction is executed. Similarly, the cycle counter is incremented by one when a timing pulse is traversed. After executing the sixth instruction, the assessment point is encountered in step 314 (label 504 in FIG. 5). In step 316, the microprocessor jumps from the normal operating mode into a circuit emulation mode. In step 317, the values inside the instruction counter and the cycle counter are read out. Finally, in step 318, performance of the microprocessor with respect to the instructions is evaluated.

As shown in FIG. 5, a total of five cycles is used to execute instruction 5 and 6. Hence, on average, an instruction requires 5/2 cycles.

In summary, this invention is able to find the average speed of operation for a group of instructions.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of determining the performance of a microprocessor having a circuit emulation mode and a normal operating mode, wherein the performance of a program having a plurality of instructions is assessed, comprising the steps of:
triggering the microprocessor into the circuit emulation mode;
resetting an instruction counter and a cycle counter to zero;
triggering the microprocessor into the normal operating mode and executing the program;
initializing the counting by the instruction counter such that the instruction counter increments by one when an instruction is executed, wherein the microprocessor is triggered into the circuit emulation mode when the instruction counter reaches an upper value, the value inside the instruction counter and the cycle counter is read to evaluate execution performance and then the microprocessor is triggered into the circuit emulation mode again;
initializing the counting by the cycle counter such that the cycle counter increments by one when a timing pulse traverses a cycle, wherein the microprocessor is triggered into the circuit emulation mode when the cycle counter reaches an upper value, the value inside the instruction counter and the cycle counter is read to evaluate execution performance and then the microprocessor is triggered into the circuit emulation mode again;
triggering the microprocessor into the circuit emulation mode when the program is executed to a definite point;
reading out the value inside the instruction counter and the cycle counter; and
evaluating microprocessor performance.

2. The method of determining microprocessor performance of claim 1, wherein the method further includes the following steps:
triggering the microprocessor into the circuit emulation mode on complete execution of the program;
reading out the value inside the instruction counter and the cycle counter; and
evaluating microprocessor performance.

3. The method of determining microprocessor performance of claim 2, wherein the method further includes the following steps:
setting up an assessment point at an instruction where execution speed is required;
triggering the microprocessor into the circuit emulation mode when the assessment point is encountered during instruction execution;
reading out the value inside the instruction counter and the cycle counter; and
evaluating microprocessor performance.

4. The method of determining microprocessor performance of claim 3, wherein the method further includes the following steps:
setting up an assessment point at the start and at the end of a series of instructions where execution speed is required;
triggering the microprocessor into the circuit emulation mode when the start assessment point is encountered during instruction execution;
reading out the value inside the instruction counter and the cycle counter;
triggering the microprocessor into the circuit emulation mode;
resetting the instruction counter and the cycle counter to zero;
triggering the microprocessor into the normal operating mode and executing the program;
initializing the counting by the instruction counter such that the instruction counter increments by one when an instruction is executed;
initializing the counting by the instruction counter such that the cycle counter increments by one when a timing pulse is traversed;
triggering the microprocessor into the circuit emulation mode when the ending assessment point is encountered;
reading out the value in the instruction counter and the cycle counter; and
evaluating microprocessor performance.

5. The method of determining microprocessor performance of claim 4, wherein the evaluation of microprocessor performance includes:
dividing the value inside cycle counter by the value inside the instruction counter

6. A device for determining the performance of a microprocessor execution, comprising:
a microprocessor capable of operating in a circuit emulation mode and a normal operating mode,
an instruction counter for counting up by one whenever an instruction is executed, and when the instruction counter counts to an upper limit, the microprocessor is triggered into the circuit emulation mode, the values within the instruction counter and the cycle counter are read out; and
a cycle counter for counting up by one whenever one cycle of timing pulse is traversed, and when the cycle counter counts to an upper limit, the microprocessor is triggered into the circuit emulation mode, the values within the instruction counter and the cycle counter are read out, wherein microprocessor performance is evaluated by dividing the value inside the cycle counter by the value inside the instruction counter.

7. A method of determining the performance of a microprocessor having a circuit emulation mode and a normal operating mode, wherein the performance of a program having a plurality of instructions is assessed, comprising the steps of:
triggering the microprocessor into the circuit emulation mode;
resetting an instruction counter and a cycle counter to zero;
triggering the microprocessor into the normal operating mode and executing the program;
initializing the counting by either the instruction counter such that the instruction counter increments by one when an instruction is executed, or by the cycle counter such that the cycle counter increments by one when a timing pulse traverses a cycle, wherein the microprocessor is triggered into the circuit emulation mode when the instruction counter reaches an upper value if the instruction counter is initialized, wherein the microprocessor is triggered into the circuit emulation mode when the cycle counter reaches an upper value if the cycle counter is initialized;
reading the value inside the instruction counter and the cycle counter to evaluate execution performance and then the microprocessor is triggered into the circuit emulation mode again,
triggering the microprocessor into the circuit emulation mode when the program is executed to a definite point;
reading out the value inside the instruction counter and the cycle counter; and
evaluating microprocessor performance.

8. The method of determining microprocessor performance of claim 7, wherein the method further includes the following steps:
triggering the microprocessor into the circuit emulation mode on complete execution of the program;
reading out the value inside the instruction counter and the cycle counter; and
evaluating microprocessor performance.

9. The method of determining microprocessor performance of claim 8, wherein the method further includes the following steps:
setting up an assessment point at an instruction where execution speed is required;
triggering the microprocessor into the circuit emulation mode when the assessment point is encountered during instruction execution;
reading out the value inside the instruction counter and the cycle counter; and
evaluating microprocessor performance.

10. The method of determining microprocessor performance of claim 9, wherein the method further includes the following steps:
setting up an assessment point at the start and at the end of a series of instructions where execution speed is required;
triggering the microprocessor into the circuit emulation mode when the start assessment point is encountered during instruction execution;
reading out the value inside the instruction counter and the cycle counter;
triggering the microprocessor into the circuit emulation mode;
resetting the instruction counter and the cycle counter to zero;
triggering the microprocessor into the normal operating mode and executing the program;
initializing the counting by the instruction counter such that the instruction counter increments by one when an instruction is executed;
initializing the counting by the instruction counter such that the cycle counter increments by one when a timing pulse is traversed;
triggering the microprocessor into the circuit emulation mode when the ending assessment point is encountered;
reading out the value in the instruction counter and the cycle counter; and
evaluating microprocessor performance.

11. The method of determining microprocessor performance of claim 10, wherein the evaluation of microprocessor performance includes:
dividing the value inside cycle counter by the value inside the instruction counter.
